(19) United States
(12) Patent Application Publication
(10) Pub. No.: US 2009/0287969 A1
(43) Pub. Date: Nov. 19, 2009

(54) ELECTRONIC APPARATUS AND BIT ERROR RATE TOLERANCE METHOD FOR PROGRAMMING NON-VOLATILE MEMORY DEVICES

(75) Inventors: Brandon L. White, Cypress, TX (US); Danny Tjandra, Houston, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BPM Microsystems, Houston, TX (US)

(21) Appl. No.: 12/423,140

(22) Filed: Apr. 14, 2009

Related U.S. Application Data
(60) Provisional application No. 61/052,889, filed on May 13, 2008.

(51) Int. Cl. G06F 11/07

(52) U.S. Cl. 714/704; 714/E11.024

(57) ABSTRACT

The present invention provides an apparatus and method for using a bit error rate tolerance (BERT) technique for high-speed programming of non-volatile electronic memory devices. The device programmer is comprised of an embedded computer system and specialized electronic circuitry to interface to the device to be programmed. According to one aspect of the invention, the device programmer contains digital registers to accumulate the number of incorrect data bits encountered during the verification of the device programming operation. A field-programmable input to the device programmer specifies the BERT to be allowed at precise intervals within the device. Devices that are found to exceed the specified BERT shall be rejected.

### CROSS-REFERENCES TO RELATED APPLICATIONS

This application claims priority from U.S. Provisional Patent Application No. 61/052,889, filed May 13, 2008, entitled “ELECTRONIC APPARATUS AND BIT ERROR RATE TOLERANCE METHOD FOR PROGRAMMING NON-VOLATILE MEMORY DEVICES.” This application is hereby incorporated by reference in its entirety for all purposes.

### BACKGROUND OF THE INVENTION

1. Field of Invention

The present invention relates to the field of automated transfer of electronic data into non-volatile digital memory devices. In particular, the present invention relates to electronic systems and methods for detection of erroneous data occurring in such devices during data transfer.

2. Description of the Related Art

In the electronics manufacturing industry, it is often desirable to transfer data into a non-volatile semiconductor device, such as flash memory, using special purpose programming machines known as device programmers. Employing device programmers to handle this task is often necessary to achieve an initial state in the device such that it may then be assembled into a larger electronic system, known as an embedded system. This pre-programming of an initial state allows the manufactured system to achieve basic functionality for further programming of the device by other means, usually as a function of the manufactured embedded system itself. This practice may also extend to other areas related to electronics manufacturing that include, but are not limited to, research and development, and failure analysis.

It is often practical to utilize the device programmer to pre-program all intended data into the device during manufacture as a cost reduction technique. Embedded systems may have particular design attributes such as low power consumption combined with reduced performance processing units that achieve less than maximal data transfer rates of the memory device. Device programmers can often achieve much more rapid transfer times which can increase the rate of system manufacture thereby lowering the per-unit manufacturing cost.

Certain types of modern, large capacity, non-volatile memory devices, such as NAND Flash, exhibit reliability errors in the data stored in the device. These errors manifest as output data that contains unpredictable differences from the original input data. The frequency of these errors increases with the repeated erasure and programming of the cells internal to the device. It is a burden of the system that interfaces to the flash device to detect and correct such errors, where possible.

To improve the accuracy of the data transferred out of a non-volatile memory device, e.g., a flash device, to a level acceptable by the application of the system, error correction code (ECC) algorithms are widely used. Such algorithms compute code values in relation to the data to be stored in the device. These code values are typically stored in the flash device itself along with the original data. Upon transfer of data output from the flash device, the code data is output as additional information. The system receiving the data from the flash device makes use of a decoding algorithm that utilizes the code to detect, and in most cases correct, incorrect binary data states in the received transfer.

A limitless number of practical implementations of ECC techniques exist. There are various encoding and decoding algorithms, and each can be varied in numerous ways to suit particular requirements as will be understood to those skilled in the art. The frequency and manner in which the code values are arranged in relation to the original data presents yet another vast mixture of possibilities. Additionally, some systems are known to combine multiple ECC implementation techniques in a dynamic hybrid fashion (see, e.g., US Pat. App. Pub. No. 20040083333A1, which is hereby incorporated by reference).

ECC algorithms are designed in a manner such that the decoding operation indicates the number of individual bit errors present in the data transferred from the device, if any. Furthermore, an additional computation can then be performed in the event of such bit errors so as to correct these errors. Generally, ECC algorithms can correct some lesser number of errors than can be detected. For instance, a 4-bit ECC algorithm may be able to detect the presence of 5 or more invalid bits in a block of data, but is only capable of precisely identifying and thus correcting 4 of the erroneous bits. The integrity of the embedded system can be maintained so long as the bit error rate (BER) for any block of data transferred from the flash memory device does not exceed the correction limits of the ECC algorithm used to encode that data block.

ECC algorithms require complex computations and as such incur latencies when the system accesses the data in the device. Generally, the stronger the ECC algorithm in terms of the number of bit correction ability, the more computational overhead is required. ECC algorithms may be implemented as software instructions for a processing unit, or may be implemented in whole or in part on dedicated hardware logic circuitry to increase the performance of the computations.

When pre-programming a NAND flash device by way of a device programming machine, data corruption failures must be detected. If these failures exceed the limits of the target embedded system's ECC algorithm correction capability, then the device must be rejected and excluded from further assembly into the target system circuit.

In the prior art, device programmers leveraged the assumption that NAND flash devices would not yield bit errors during manufacturing pre-programming due to the lack of disturbance issues in new devices. While this certainly remains true for Single Level Cell (SLC) NAND flash devices, Multiple Level Cell (MLC) devices can and will in fact experience program disturbance issues on the first and subsequent program operations that will lead to incorrect bit states upon transfer of the data from the device.

Applying conventional device programmer methods to MLC NAND flash devices results in unsuccessful yield, as nearly all devices would be rejected by the machine upon detection of the erroneous data bits in the output.

Implementing the ECC algorithm used by the embedded system in the device programmer is an obvious but inadequate solution. The computational overhead for these algorithms is not suitable for the rates desired for electronics manufacturing. Furthermore, the exact details of any particular embedded system's ECC methods might be difficult or impossible to obtain. Advanced ECC methods are often proprietary, with multiple parties involved and the license for such use untenable. Lastly, the cost to develop such algorithms on a per-device, per-system basis is typically prohibitive.

Therefore, a need exists for a device programming machine with an improved method and apparatus for data verification within a bit error rate tolerance threshold. That is, what is desired is a method and apparatus for high-speed pre-programming of MLC NAND Flash or other non-volatile memory devices within the capabilities of any arbitrary ECC algorithm without employing such algorithms directly.

### BRIEF SUMMARY

Briefly, the present invention provides an apparatus and method for using a bit error rate tolerance (BERT) technique for high-speed programming of non-volatile electronic memory devices. The device programmer, in certain aspects, includes an embedded computer system and specialized electronic circuitry to interface to the device to be programmed.

According to one embodiment, a method for using a bit error rate tolerance technique during high-speed programming of non-volatile memory devices is disclosed. The method comprises receiving a tolerance value representing a maximum number of bit errors that a memory region in a non-volatile memory device can tolerate. Next, the method analyzes a memory region of the non-volatile memory device to find the number of bit errors contained in the memory region of the device without running an error correcting code algorithm. The method then compares the number of bit errors found in the analyzed memory region of the non-volatile memory device to the tolerance value. Non-volatile memory devices in which the number of bit errors found in the analyzed memory region of the non-volatile memory device is greater than the tolerance value are then rejected.

According to another embodiment, a device programmer apparatus for programming a non-volatile memory device is disclosed. The apparatus comprises a means for storing data to be transferred into memory of a non-volatile memory device, a means for transferring data into memory of the non-volatile memory device, a means for analyzing a memory region of the non-volatile memory device that stores the transferred data to find the number of bit errors contained in the memory region without running an error correcting code algorithm, a means for comparing the number of bit errors found in the analyzed memory region of the non-volatile memory device to a tolerance value representing a maximum number of bit errors that a memory region in the memory device can tolerate, and a means for rejecting the non-volatile memory device if the number of bit errors found in the analyzed memory region of the non-volatile memory device is greater than the tolerance value.

According to another embodiment, a computer readable medium with computer-executable code is disclosed. The computer-readable medium comprises code for receiving a tolerance value representing a maximum number of bit errors that a memory region in a non-volatile memory device can tolerate, code for analyzing a memory region of the non-volatile memory device to find the number of bit errors contained in the memory region of the device without running an error correcting code algorithm, code for comparing the number of bit errors found in the analyzed memory region of the non-volatile memory device to the tolerance value, and code for rejecting the non-volatile memory device if the number of bit errors found in the analyzed memory region of the non-volatile memory device is greater than the tolerance value.

According to another embodiment of the invention, a device programmer contains digital registers to accumulate the number of incorrect data bits encountered during the verification of the device programming operation. A field-programmable input to the device programmer specifies a bit error rate tolerance (BERT) to be allowed at precise intervals within the device. Devices that are found to exceed the specified BERT can be rejected and visually indicated as such by the machine.

According to another embodiment of the present invention, a BERT input is set according to the ECC capabilities of the target system into which the device will be assembled. A device programmer will only indicate successful programming status for devices that contain a number of bit errors equal to or less than the correction capabilities of the target system's ECC algorithm. Devices failing to meet this specification can be rejected and visually indicated as such by the machine to prevent further assembly of the device into the target system, thereby avoiding the assembly of a non-functional target system.

In another embodiment, an apparatus includes the circuitry and implements simultaneous programming of multiple quantities of devices. Each device's error statistics are computed and retained discretely by the device programmer circuitry in real-time, as is necessary to manage the random distribution of possible error bits on individual devices.

According to still another aspect of the present invention, multiple BERT inputs may be specified by the operator of the device programmer, as desired, to accommodate varying tolerances for different memory regions of the memory device.

Further aspects and advantages of the present invention shall become apparent upon reading and understanding the following detailed descriptions of example embodiments and studying the various figures of the drawings.

### BRIEF DESCRIPTION OF THE DRAWINGS

FIG. 1 is a diagrammatic representation of the device programmer embedded system electronic modules, according to one embodiment.

FIG. 2 is a diagrammatic representation of the digital logic system implemented within the Field Programmable Gate Array (FPGA) electronic module, according to an embodiment.

FIG. 3 is a diagrammatic representation of the Verify Engine sub-module containing the digital logic for the BERT method within, in accordance with an embodiment.

FIG. 4 is a process flow diagram, which illustrates the BERT state-machine method according to one embodiment.

FIG. 5 is a process flow diagram, which illustrates a BERT reset state-machine method for detecting the transition of the address into a new tolerance region of the device, according to one embodiment.

### DETAILED DESCRIPTION

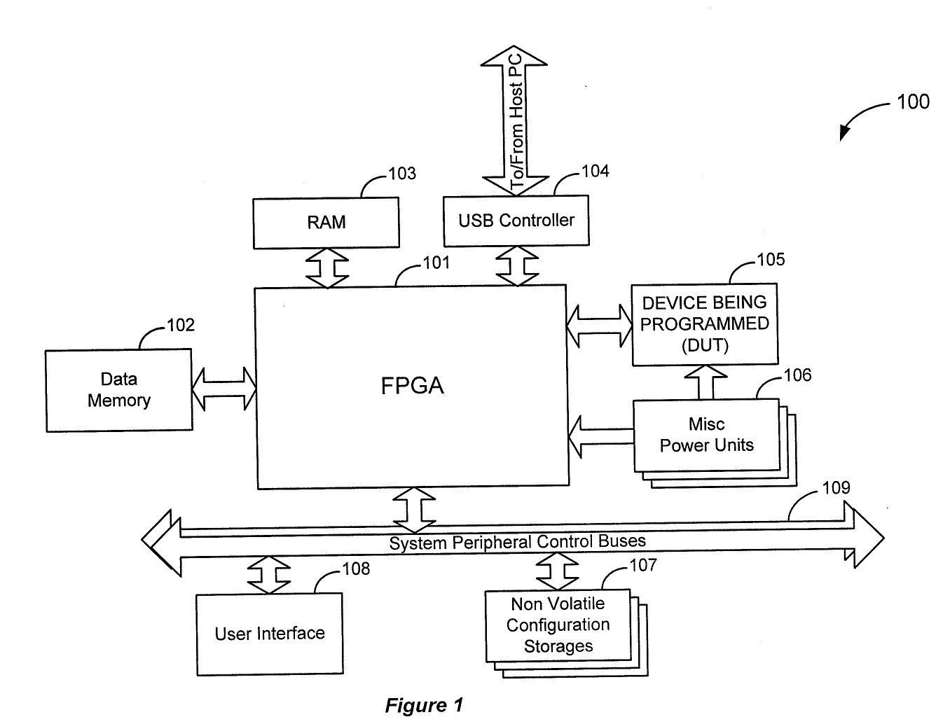

FIG. 1 shows an example of a device programming embedded system 100 including various electronic modules. At the center of the diagram is the Field Programmable Gate Array (FPGA) 101 according to one embodiment. In the embodiment illustrated in FIG. 1, the FGPA is the module that contains much of the logic that carries out the high-speed pre-programming of devices. Surrounding the FPGA are other modules that help the FPGA carry out its functions. Among these modules are Data Memory 102, RAM 103, a USB Controller 104 connected to a host PC, miscellaneous power units 106, non-volatile storage 107, and a user interface module 108. The Device to be Programmed, or Device Under Test (DUT), 105 is inserted into the device programming embedded system 100 by a user of the system through an appropriate connection. It is through this connection that the device programming embedded system 100 communicates with the DUT 105 and programs it.

Some of the modules shown in the embodiment illustrated in FIG. 1 are directly used to implement the process outlined below. For example, the FGPA 101 and the Data Memory 102 are components used in implementing the BERT technique according to the embodiment illustrated in FIG. 1 as well as various other embodiments. Other components illustrated in FIG. 1, such as the user interface 108 and non-volatile storage 107, can be used for configuration, storage, and reporting purposes. It is possible that alternative embodiments could include additional modules or exclude some of the modules shown here, depending on the particular needs of the device programmer and the device to be programmed.

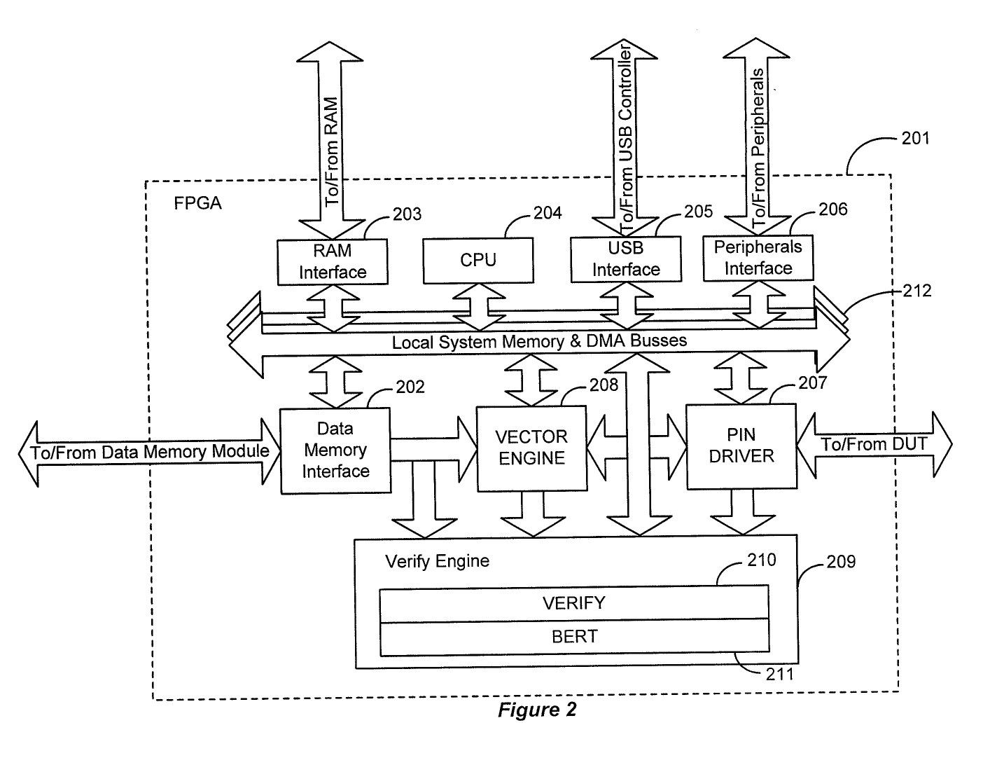

FIG. 2 shows a more detailed view of an FPGA 201 according to one embodiment. The FPGA 201 in this diagram may be the same as the FPGA 101 from FIG. 1. FIG. 2 also shows how many of the modules illustrated in FIG. 1 connect to the FPGA 201. For example, the RAM Interface 203, USB Interface 205, Peripherals Interface 206, Data Memory Interface 202, and PIN Driver 207 all reside on the Local System Memory and DMA Buses 212 and connect the FPGA 201 to many of the external modules shown in FIG. 1. Of course, if other devices are connected to the FPGA 201, then those devices would also typically need the appropriate hardware, interface, or other means for connecting the device to the FPGA 201.

In FIG. 2, the Vector Engine 208 and the Verify Engine 209 are the components of the FPGA that contain the logic for programming the DUTs and verifying the bits copied to the DUTs. The Vector Engine handles the application of waveform signals to the DUTs during programming and verification, and the Verify Engine checks the output of the DUTs for errors during verification after the initial programming is complete. These engines can be implemented in software, hardware, or some combination of hardware and software. While the embodiment shown in FIG. 2 shows these two engines as distinct modules, alternative embodiments are possible where the logic to be executed in these modules actually reside within the same module of the FPGA.

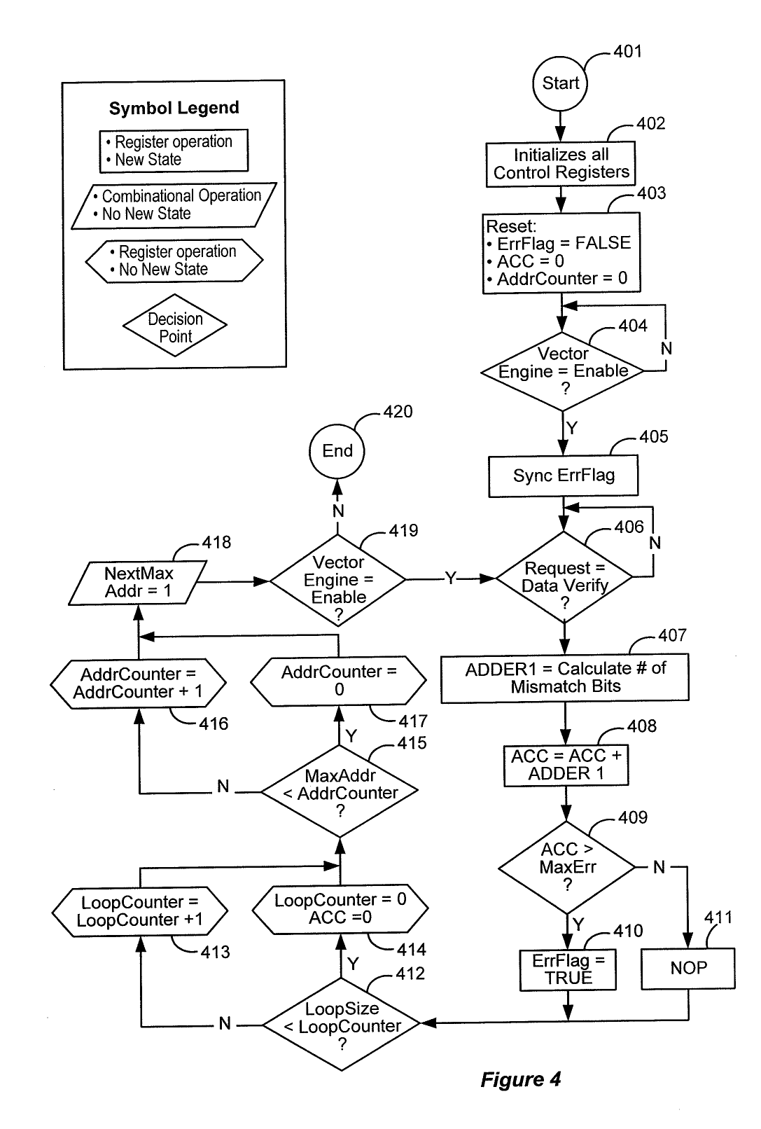

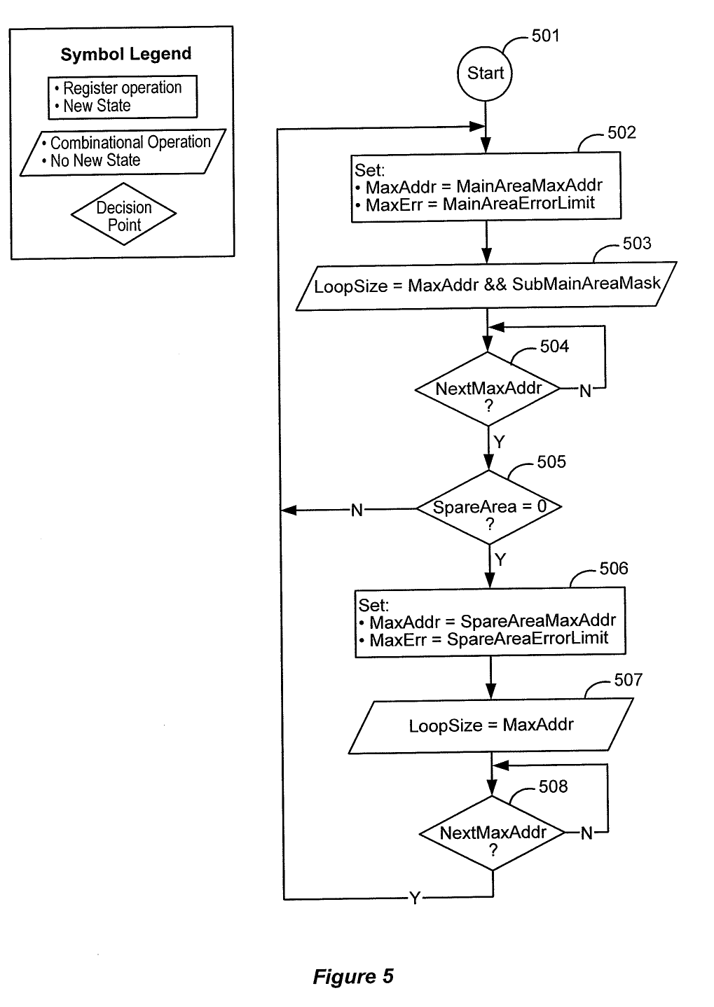

Within the Verify Engine 209, two sub-modules are shown: Verify 210 and BERT 211. The Verify sub-module 210 contains the logic used to capture data output from the DUTs and to verify its correctness against the Data Memory 102 via the Data Memory Interface 202. Detected verification errors are fed into the BERT sub-module 211. The BERT sub-module 211 implements the techniques further discussed in FIGS. 4 and 5.

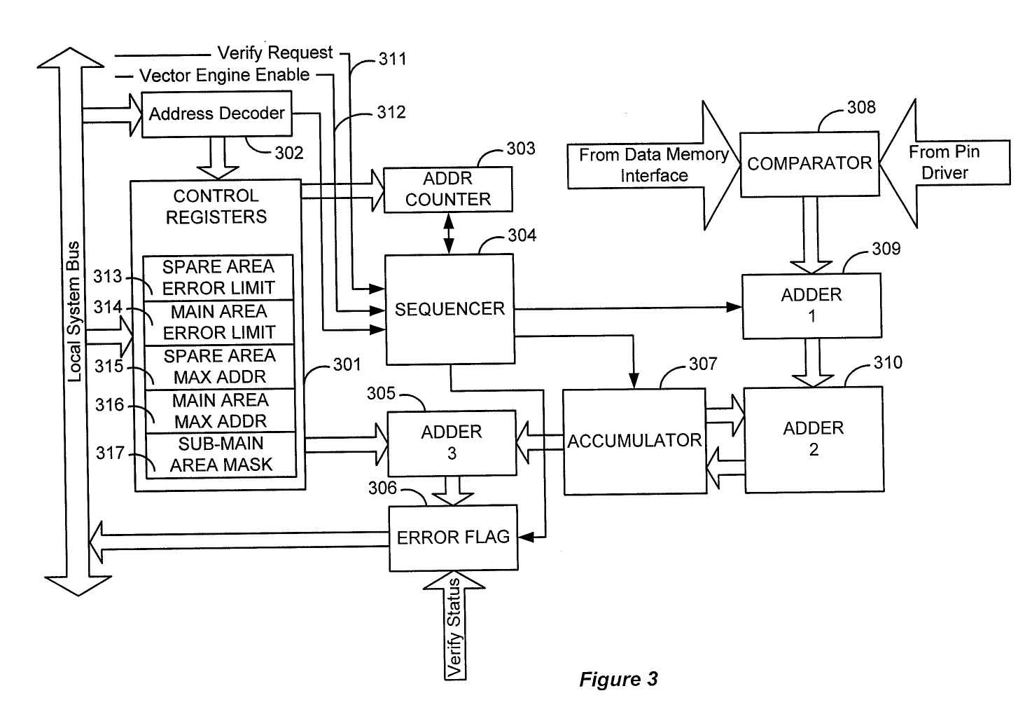

FIG. 3 shows many components that help implement the logic of the BERT sub-module 211 in one embodiment. In the Control Registers 301, there are various registers that are useful for tracking the area of memory to be checked with the BERT technique as well as storing the limits for the acceptable number of bit errors in the DUT. Examples of how registers 313-317 are used during the BERT process are shown in FIGS. 4 and 5. There is also a Comparator 308 that performs the actual bit comparisons between the bits recorded in the memory of the DUT and a copy of the bits as they were intended to be copied. Additional components that can be used for carrying out this process, such as a Sequencer 304, Address Decoder 302, ADDR Counter 303, Accumulator 307, and various other ADDER registers are also represented in the diagram. All of these well-known components are used to implement the logic behind the BERT technique. One skilled in the art will recognize that different embodiments of these components may be implemented in hardware, software, or in other combinations.

FIG. 3 also shows an example of how the BERT sub-module can be connected with various other components in the device programmer. For instance, the Sequencer 304 reads signals from both the Verify Engine through Verify Request line 311 and also from the Vector Engine in the through the Vector Engine Enable line 312. Also, Error Flag 306 is accessed by the Verify Engine to see whether a DUT has successfully passed inspection by the BERT technique. The Comparator 308 also reads data from both the DUT via the Pin Driver and from Data Memory via the Data Memory Interface, and compares the two to detect any differences.

FIG. 4 is a process flow diagram that illustrates one embodiment of a BERT technique implemented in a state machine to count the number of bit errors present on a device. This example BERT state machine can be implemented on hardware and software such as the example shown in FIG. 3.

The process starts at step 401. At step 402, all of the Control Registers 301 are initialized to the appropriate starting values for the process. These registers will typically define the area of memory to be checked, any sub-areas of memory to be checked, the number of memory errors the device can tolerate before the device is considered a failure, and perhaps other useful data such as mask data.

In addition to initializing the Control Registers 301, which should need to only be initialized once, there are other data fields that must be initialized for each individual DUT to be examined. This second batch of initialization is represented in step 403. In the embodiment shown in FIG. 4, ErrFlag is set to FALSE, ACC is set to 0, and AddrCounter is also set to 0. These variables can be mapped to the registers from FIG. 3. For example, ErrFlag can correspond to Error Flag 306, ACC can correspond to Accumulator 307, and AddrCounter can correspond to ADDR Counter 303. ErrFlag is set when a memory region of the DUT contains more errors than what the DUT can tolerate. ACC is used to track the running total of errors encountered in a memory region of the DUT. AddrCounter is used to track the address of memory undergoing analysis by the BERT technique.

At step 404 the sub-module implementing the BERT state machine waits for the Vector Engine to give the BERT state machine the clearance to begin its process. In this embodiment, this is accomplished by having the BERT sub-module wait for the Vector Engine to set a flag to indicate that the DUT is ready to have its memory checked for bit errors. This can be signaled to the BERT state machine through the Vector Engine Enable line 312, although other well-known techniques can also be used to accomplish this task. Otherwise, the BERT state machine must remain in an idle state during other operations on the DUT that do not involve BERT verification such as erasure, blank checking, and programming.

After the BERT state machine has verified that the Vector Engine has given clearance for the BERT technique to proceed, the BERT state machine synchronizes the ErrFlag. This is shown at step 405. This is done because there may have been a change in the proper value of the ErrFlag as a result of operations conducted on the DUT while the BERT state machine was waiting for the Vector Engine to set the Enable flag in step 404. It is possible that the Vector Engine could directly update the ErrFlag in the BERT state machine because some other error occurred during programming that renders the DUT a failure, but that may not always be the case. Thus, the BERT state machine may need to check modules in the Device Programmer to synchronize the ErrFlag to its correct value at this point in the process.

At step 406 the BERT state machine waits for the Verify sub-module to request the BERT to run its bit error analysis. Just as with the step 404, the BERT state machine waits for clearance from the Verify sub-module before beginning its operation. This signal can be communicated to the BERT state machine through the Verify Request 311 line or any other suitable technique. This waiting step prevents the BERT state machine from initiating inspection of the bit failures until the Verify sub-module has this information available.

After the BERT state machine has received the clearance from the Verify sub-module, the process of checking the bits in the DUT begins at step 407. In step 407, the bits in the DUT at the address represented by AddrCounter are checked against the bits from the corresponding address in Data Memory in order to count how many bits are mismatched. This analysis can be done by the Comparator 308. There are many possible ways that this analysis can be conducted. For example, the bits from the DUT and the bits from Data Memory could be combined through a bitwise XOR operation. The number of bits in the output of this operation set to “1” could then be totaled to achieve the total number of mismatched bits in this data segment. One skilled in the art will recognize that many other suitable methods for calculating the number of mismatched bits are available and can be implemented in the alternative. In the present embodiment, the total number of mismatched bits from this comparison is stored in register ADDER1 309.

At step 408 the value stored in ADDER1 309 is combined with the value of the ACC, which updates the running total of mismatched bits found in the DUT.

At step 409, the value of the ACC is then compared with the MaxErr, which is set to either register 313 or 314 in this embodiment depending upon the tolerance region of the DUT being verified at that particular point in time. If the number of errors recorded in the ACC is greater than MaxErr, then the bit in ErrFlag corresponding to the tolerance region is set to TRUE in step 410. Otherwise, ErrFlag is not modified and processing of the DUT continues through step 411.

The value of MaxErr depends on the configuration of the BERT analysis being conducted on the DUT. In some instances there may be a limit not only on the number of errors contained in the DUT's memory as a whole, but also on the number of errors contained in a given area of memory. This given area of memory can be referred to as a tolerance region. For example, ECC coding may be applied to the DUT's memory in pages, where each page has a maximum number of errors that can be corrected through the ECC algorithm applied to the data. MaxErr might have one value for data segment of memory and a different value for the spare-area segment of memory. FIG. 5, discussed further below, gives an example of how the BERT state-machine can move through different tolerance regions in the DUT and apply different values for system parameters such as SpareAreaLimit 313 and MainAreaLimit 314.

After MaxErr has been compared to the number of errors detected in step 409 the BERT state machine runs through a number of steps to check its progress through the address space of the DUT. In step 412 LoopCounter is compared with LoopSize. This check allows this embodiment to check the number of bit errors present in a sub-segment of memory. For example, any errors present in one sub-segment of memory must not contribute to the error rate of another sub-segment and so the memory area to be analyzed in the DUT has to be broken up into smaller pieces. If the segment of memory has been fully checked for bit errors, then LoopSize will be less than LoopCounter, and the LoopCounter and ACC will be reset to 0 as in step 414. Otherwise, LoopCounter will be incremented as shown in step 413. The loop size can be set to be the same as the MaxAddr size so that in effect the entire memory space to be checked is considered to be one LoopSize.

In step 415 a check similar to the check at step 412 is conducted. The difference is that the check at step 415 is conducted on the progress made through the entire memory space rather than just a loop segment. If the AddrCounter shows that the BERT state machine has checked all of the addresses up to and including the MaxAddr, then the AddrCounter is reset. Otherwise, the AddrCounter is incremented so that the next error region of the DUT can be inspected.

At step 418, NextMaxAddr is set to 1. This variable is re-initialized to prepare the BERT state machine to process the next tolerance region by subsequently causing MaxErr to be set to the next region's error rate limit and MaxAddr to be set to the next region's highest address offset. As shown in FIG. 5, other operations in the Verify Engine may take place before the BERT state machine checks the next memory segment of the DUT for bit errors.

At step 419, the Vector Engine is checked again to see if it is set to “Enable.” This is similar to the check done at step 404. If it is detected that the Vector Engine has set the line to “Enable,” then the state machine returns to step 406 and processing continues from that point in the state machine. Otherwise, the BERT processing is complete and the state machine, completes until signaled by the CPU to start again.

As is demonstrated in steps represented in FIG. 4, none of the individual operations that make up the BERT process are complicated or time consuming processes. This allows the entire process to take place very rapidly. The amount of time and resources spent conducting this analysis is a function of the number of bits to be checked, not any ECC algorithm implemented. For instance, with well-designed pipelining each DUT address can be verified with BERT per system clock.

It is possible that other optimizations could be implemented in the steps shown in FIG. 4. For example, once it is determined that ErrFlag is going to be set to TRUE, it may be possible to cease further processing on the DUT since the DUT will be rejected. Other optimizations may also be appropriate based on the goals of the given embodiment of the invention.

FIG. 5 shows an example of a BERT reset state-machine method for detecting the transition into a new tolerance region of the device according to one embodiment. A tolerance region is a region of memory that is grouped together for BERT purposes. For example, a tolerance region could be an area of memory that is grouped together for ECC purposes and each tolerance region in memory may have an independent bit failure tolerance limit.

In a given tolerance region, there are potentially two or more potential sub-areas. In the embodiment illustrated in FIG. 5, there are two different sub-areas that are each checked for bit errors individually. The two sub-areas represented in FIG. 5 are a Main Area and a Spare Area. An example of how these two areas can be used is related to ECC. The Main Area could hold the data related to the actual content or data to be used by a later application. The Spare Area could hold the error-correcting data used to correct any bits that may have been improperly transferred to the DUT. It is clear that the number of sub-areas can be custom tailored to fit the needs of a given application, and the process in FIG. 5 can be easily extended to accommodate additional sub-areas.

In the example state machine shown in FIG. 5, the process begins at step 501. In step 502, the state machine sets the MaxAddr and the MaxErr to the values appropriate for the region about to be examined. MaxAddr defines the top address in the area of memory to be checked. MaxErr defines the maximum number of bit errors that are acceptable in the memory region to be checked. The values for these variables can vary for different DUTs and different sets of data to be transferred into a DUT.

At step 503, LoopSize is calculated. As discussed earlier, LoopSize is used by the BERT state machine to break up the memory area to be checked into chunks. In this instance, LoopSize is determined by applying SubMainAreaMask to MaxAddr through a “&&” operation. There are many other possible ways to calculated LoopSize.

Once the steps at 502 and 503 are completed, the state machine then waits for NextMaxAddr to be set to TRUE or 1. The BERT state machine checks the main memory area for bit errors while the state machine waits in this loop. One skilled in the art will recognize that other triggering or signaling mechanisms can be used at this step as well.

After the state machine recognizes that the main address has been fully checked for bit errors, the state machine checks to see if there is any spare area that needs to be checked. If there is no spare memory area to be checked, then the State Machine returns to its initial state and waits for the next DUT to be checked. If there is a spare area to be checked, then the process outlined in steps 506, 507, and 508 are executed. These steps are very similar to steps 502, 503, and 504, but use different values for MaxAddr, MaxErr, and LoopSize. In the example embodiment shown, MaxAddr is set to SpareAreaMaxAddr, MaxErr is set to SpareAreaErrorLimitm and LoopSize is set to MaxAddr. Since LoopSize is set to be the same as MaxAddr in this example, then only one “loop” needs to be made through the Spare Area since the size of the loop is the same size as the entire Spare Area. Once these variables are set, the state machine again waits for the memory area to be checked for bit errors. After the bit error check is complete, the state machine returns to its initial state to wait for the next DUT to be checked.

Any software components or functions described herein may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The modules, sub-modules, and other components referenced in this description can be implemented in a variety of ways. The selection of particular means for implementing the above described features is illustrative but not restrictive. Many variations of the invention will become apparent to those skilled in the art upon review of the disclosure. For example, while many pieces of data used by the invention are represented as being stored in registers, there is no reason why the same pieces of data could not be stored in RAM or in other locations. The scope of the invention should, therefore, be determined not with reference to the above description, but instead should be determined with reference to the pending claims along with their full scope or equivalents.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method for using a bit error rate tolerance technique during high-speed programming of non-volatile memory devices, the method comprising:
receiving a tolerance value representing a maximum number of bit errors that a memory region in a non-volatile memory device can tolerate;
analyzing a memory region of the non-volatile memory device to find the number of bit errors contained in the memory region of the device without running an error correcting code algorithm;
comparing the number of bit errors found in the analyzed memory region of the non-volatile memory device to the tolerance value; and
rejecting the non-volatile memory device if the number of bit errors found in the analyzed memory region of the non-volatile memory device is greater than the tolerance value.

2. The method of claim 1 wherein the tolerance value is determined using a function of an error correcting code algorithm used to encode the data transferred into the non-volatile memory device.

3. The method of claim 1 wherein the memory region is one of a plurality of memory regions in the non-volatile memory device, wherein the steps of analyzing, comparing, and rejecting are repeated for each memory region of the device.

4. The method of claim 1 wherein the step of analyzing a memory region comprises using a bitwise XOR operation to find the number of bit errors contained in the memory region of the device.

5. The method of claim 1 wherein the memory region comprises a main memory area and a spare memory area, wherein the analyzed memory region is the main memory area, the method of claim 1 further comprising:
receiving a second tolerance value representing a maximum number of bit errors that a spare memory area in the non-volatile memory device can tolerate;
analyzing the spare memory area of the non-volatile memory device to find the number of bit errors contained in the spare memory area of the device;
comparing the number of bit errors found in the analyzed spare memory area of the non-volatile memory device to the second tolerance value; and
rejecting the non-volatile memory device if the number of bit errors found in the spare memory area of the non-volatile memory device is greater than the second tolerance value.

6. The method of claim 5 wherein the tolerance value and the second tolerance value are not the same value.

7. The method of claim 5 wherein the spare memory area stores error correcting data that can be used to correct bit errors in the main memory area.

8. The method of claim 1 further comprising:
analyzing a memory region of a second non-volatile memory device to find the number of bit errors contained in the memory region of the second device without running an error correcting code algorithm;
comparing the number of bit errors found in the analyzed memory region of the second non-volatile memory device to the tolerance value; and
rejecting the second non-volatile memory device if the number of bit errors found in the analyzed memory region of the second non-volatile memory device is greater than the tolerance value;
wherein the non-volatile memory device and the second non-volatile memory device are analyzed, compared, and rejected substantially at the same time.

9. The method of claim 1 wherein the non-volatile memory device is a multiple level cell NAND flash device.

10. The method of claim 1 further comprising:
assembling the non-volatile memory device into an embedded system if the device is not rejected.

11. A device programmer apparatus for programming a non-volatile memory device, the apparatus comprising:
means for storing data to be transferred into memory of a non-volatile memory device;
means for transferring data into memory of the non-volatile memory device;
means for analyzing a memory region of the non-volatile memory device that stores the transferred data to find the number of bit errors contained in the memory region without running an error correcting code algorithm;
means for comparing the number of bit errors found in the analyzed memory region of the non-volatile memory device to a tolerance value representing a maximum number of bit errors that a memory region in the memory device can tolerate; and
means for rejecting the non-volatile memory device if the number of bit errors found in the analyzed memory region of the non-volatile memory device is greater than the tolerance value.

12. The device programmer apparatus of claim 11 wherein the tolerance value is determined using a function of an error correcting code algorithm used to encode the data transferred into the non-volatile memory device.

13. The device programmer apparatus of claim 11 wherein the memory region is one of a plurality of memory regions in the non-volatile memory device, wherein the means for transferring, means for analyzing, and means for comparing are each adapted to operate against each memory area in the non-volatile memory device,

14. The device programmer apparatus of claim 11 wherein the means for analyzing a memory region is adapted to use a bitwise XOR operation to find the number of bit errors contained in the memory region of the device.

15. The device programmer apparatus of claim 11 wherein the memory region comprises a main memory area and a spare memory area, wherein the analyzed memory region is the main memory area, the device programmer apparatus of claim 11 further comprising:
means for selecting a second tolerance value representing a maximum number of bit errors that a spare memory area in the non-volatile memory device can tolerate;
means for analyzing the spare memory area of the non-volatile memory device to find the number of bit errors contained in the spare memory area of the device without running an error correcting code algorithm;
means for comparing the number of bit errors found in the analyzed spare memory area of the non-volatile memory device to the second tolerance value; and
means for rejecting the non-volatile memory device if the number of bit errors found in the spare memory area of the non-volatile memory device is greater than the second tolerance value.

16. The device programmer apparatus of claim 15 wherein the tolerance value and the second tolerance value are not the same value.

17. The device programmer apparatus of claim 15 wherein the spare memory area stores error correcting data that can be used to correct bit errors in the main memory area.

18. The device programmer apparatus of claim 11 wherein the non-volatile memory device is a multiple level cell NAND flash device.

19. The device programmer apparatus of claim 11 wherein the non-volatile memory device is later assembled into a larger embedded system.

20. The device programmer apparatus of claim 11 wherein the means for storing data, means for transferring data, means for analyzing a memory region, means for comparing the number of bit errors, and means for rejecting the non-volatile device are each adapted to operate on multiple non-volatile devices substantially at the same time.

21. A computer readable medium with computer-executable code comprising:
code for receiving a tolerance value representing a maximum number of bit errors that a memory region in a non-volatile memory device can tolerate;
code for analyzing a memory region of the non-volatile memory device to find the number of bit errors contained in the memory region of the device without running an error correcting code algorithm;
code for comparing the number of bit errors found in the analyzed memory region of the non-volatile memory device to the tolerance value; and
code for rejecting the non-volatile memory device if the number of bit errors found in the analyzed memory region of the non-volatile memory device is greater than the tolerance value.
